(19) United States
(12) Patent Application Publication
(10) Pub. No.: US 2010/0333159 A1
(43) Pub. Date: Dec. 30, 2010

(54) METHOD OF PRESENTING MULTIMEDIA CONTENTS OF MULTIPLE MULTIMEDIA CHANNELS BY NETWORKING AND RELATED ELECTRONIC APPARATUS AND MULTIMEDIA SYSTEM THEREOF

(75) Inventor: Yung-Chao Tseng, Taipei County (TW)

Correspondence Address: NORTH AMERICA INTELLECTUAL PROPERTY CORPORATION, P.O. BOX 506, MERRIFIELD, VA, 22116, US

(73) Assignee: CYBERLINK CORP., Taipei Hsien (TW)

(21) Appl. No.: 12/494,300

(22) Filed: Jun. 30, 2009

(51) Int. Cl. H04N 7/173

(52) U.S. Cl. 725/110; 725/118; 725/116

(57) ABSTRACT

An electronic apparatus includes a tuner, a network interface, and a controller. The tuner is implemented for tuning in one of a plurality of multimedia channels to derive a first multimedia content from a selected multimedia channel. The network interface is implemented for receiving a second multimedia content from a computer network coupled to the network interface, wherein the second multimedia content is derived from at least one of the multimedia channels. The controller is coupled to the tuner and the network interface, and is implemented for controlling operations of the tuner and the network interface, and controlling an output device to present the first multimedia content and the second multimedia content.

### BACKGROUND OF THE INVENTION

1. Field of the Invention

The present invention relates to previewing multimedia contents, and more particularly, to a method of presenting multimedia contents (e.g., channel previews) of multiple multimedia channels (e.g., television channels) by networking and related electronic apparatus and multimedia system thereof.

2. Description of the Prior Art

A large number of television channels are available over analog television systems and digital television systems. In general, when a user wants to view a television program, he/she has to control a tuner to select one of the television channels. Therefore, after the tuner is controlled to tune in a particular television channel, data of the television program transmitted via the particular television channel are derived and processed for playback. Next, the user can watch the desired television program on a display device such as a television.

However, a single tune is allowed to tune in a single television channel at a time. If the user is watching a desired television program corresponding to a television channel selected by the tuner, the user is not allowed to have a channel preview of other television channels through the same tuner. That is, if the user wants to have a channel preview of another television channel, the user cannot watch the desired television program at the same time.

Therefore, it is desired to provide a novel scheme that allows the user to have channel previews of multiple television channels simultaneously without controlling the local tuner to change the currently selected television channel which transmits the desired television program that the user is watching now.

### SUMMARY OF THE INVENTION

One of the objectives of the present invention is therefore to provide a method of presenting multimedia contents (e.g., channel previews) of multiple multimedia channels (e.g., television channels) by networking and related electronic apparatus and multimedia system thereof.

According to a first aspect of the present invention, an exemplary electronic apparatus is disclosed. The electronic apparatus includes a tuner, a network interface, and a controller. The tuner is implemented for tuning in one of a plurality of multimedia channels to derive a first multimedia content from a selected multimedia channel. The network interface is implemented for receiving a second multimedia content from a computer network coupled to the network interface, wherein the second multimedia content is derived from at least one of the multimedia channels. The controller is coupled to the tuner and the network interface, and is implemented for controlling operations of the tuner and the network interface, and controlling an output device to present the first multimedia content and the second multimedia content.

According to a second aspect of the present invention, an exemplary multimedia system is disclosed. The multimedia system includes a computer network and a plurality of electronic apparatuses communicating with each other via the computer network. The electronic apparatuses includes: a first electronic apparatus, tuning in a first multimedia channel of a plurality of multimedia channels for deriving a first multimedia content from the first multimedia channel; and a second electronic apparatus, tuning in a second multimedia channel of the multimedia channels for deriving a second multimedia content from the second multimedia channel, and requesting the first electronic apparatus for the first multimedia content via the computer network and presenting the first multimedia content and the second multimedia content.

According to a third aspect of the present invention, an exemplary method of presenting multimedia contents of multiple multimedia channels is disclosed. The method includes: tuning in a first multimedia channel of a plurality of multimedia channels for deriving a first multimedia content from the first multimedia channel, and transmitting the first multimedia content via a computer network; tuning in a second multimedia channel of the multimedia channels for deriving a second multimedia content from the second multimedia channel; receiving the first multimedia content from the computer network; and presenting the first multimedia content which is received from the computer network and the second multimedia content on an output device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an exemplary embodiment of a multimedia system according to the present invention.

FIG. 2 is a block diagram illustrating an exemplary embodiment of an electronic apparatus shown in FIG. 1.

FIG. 3 is a flowchart illustrating an operation of an electronic apparatus acting as a client in the multimedia system shown in FIG. 1.

FIG. 4 is a flowchart illustrating an operation of a server in the multimedia system shown in FIG. 1.

FIG. 5 is a schematic diagram illustrating another exemplary embodiment of a multimedia system according to the present invention.

FIG. 6 is a block diagram illustrating an exemplary embodiment of an electronic apparatus shown in FIG. 5.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

To put it simply, the conception of the present invention is to request channel preview information from one or more remote electronic apparatuses which tune in channels different from a specific channel that the local electronic apparatus tunes in now. Specifically, the transmission of the requested channel preview information is realized by a computer network, such as a wireless network or a wired network. In this way, the user is allowed to have channel previews of multiple multimedia channels (e.g., television channels) simultaneously without controlling the local tuner to change the currently selected multimedia channel which transmits the desired multimedia content (e.g., a television program) that the user is watching now. In other words, the user can still watch the desired multimedia content of a specific multimedia channel while previewing multimedia content(s) of other multimedia channel(s). To more clearly illustrate features of the present invention, certain exemplary embodiments are given as follows.

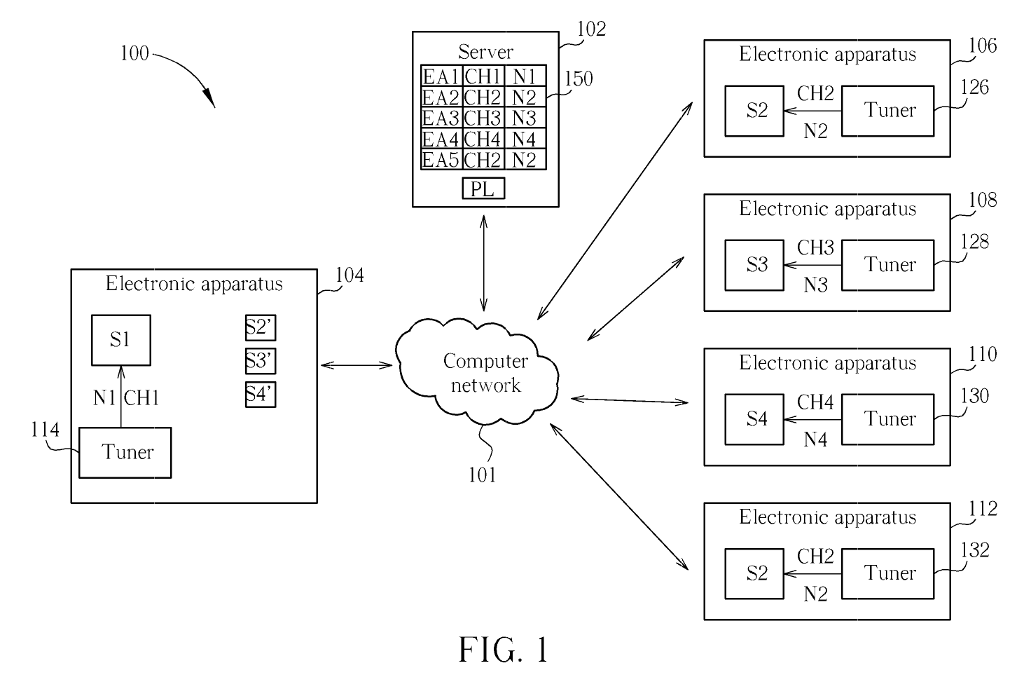

FIG. 1 is a schematic diagram illustrating an exemplary embodiment of a multimedia system according to the present invention. As shown in FIG. 1, the multimedia system 100 includes a computer network 101, a server 102 and a plurality of electronic apparatuses 104, 106, 108, 110, 112 which act as clients. In this exemplary embodiment, the electronic apparatuses 104, 106, 108, 110, 112 support the same channel preview scheme proposed by the present invention. It should be noted that the number of electronic apparatuses (clients) shown in FIG. 1 is for illustrative purposes only, and is not meant to be a limitation to the scope of the present invention. In this exemplary embodiment shown in FIG. 1, the electronic apparatuses 104, 106, 108, 110, and 112 are equipped with tuners 114, 126, 128, 130, and 132, respectively. That is, each of the electronic apparatuses 104, 106, 108, 110, and 112 serves as a data source to provide information (e.g., channel preview information) requested by one or more electronic apparatuses. As shown in FIG. 1, the tuner 114 of the electronic apparatus 104 tunes in a multimedia channel of a plurality of multimedia channels (e.g., television channels), where the channel number and channel name of the selected multimedia are denoted by CH1 and N1, respectively. As one can see, the channel number and channel name of the multimedia channel selected by the tuner 126 of the electronic apparatus 106 are denoted by CH2 and N2, respectively; the channel number and channel name of the multimedia channel selected by the tuner 128 of the electronic apparatus 108 are denoted by CH3 and N3, respectively; the channel number and channel name of the multimedia channel selected by the tuner 130 of the electronic apparatus 110 are denoted by CH4 and N4, respectively; and the channel number and channel name of the multimedia channel selected by the tuner 132 of the electronic apparatus 112 are denoted by CH2 and N2, respectively.

The electronic apparatuses 104, 106, 108, 110, and 112 and the server 102 communicate with each other via the computer network 101. In addition, each of the electronic apparatuses 104, 106, 108, 110, and 112 will notify the server 102 to update channel information (mapping) of the selected multimedia channel for updating information associated with a multimedia channel currently selected by the corresponding electronic apparatus. In other words, each time the electronic apparatus changes the channel selection, the latest channel information (mapping) of the selected multimedia channel in the server 102 is updated. For example, regarding the electronic apparatuses 104, 106, 108, 110, and 112, the server 102 has a database 150 which records the channel number and the channel name of a multimedia channel currently selected by each of the electronic apparatuses 104, 106, 108, 110, and 112 indexed by EA1, EA2, EA3, EA4, and EA5, respectively. In other words, the mapping between an electronic apparatus and a corresponding channel status thereof (e.g., channel number and channel name) is maintained in the database 150 of the server 102. However, it should be noted that the aforementioned channel information recorded in the server 102 is for illustrative purposes only, and is not meant to be a limitation to the scope of the present invention. Based on the information recorded in the database 150, the server 102 is therefore capable of managing availability such as mapping availability of electronic apparatuses which are shared.

Suppose that the user of the electronic apparatus 104 wants to have channel previews of other multimedia channels CH2, CH3, and CH4 when the tuner 114 of the local electronic apparatus (i.e., the electronic apparatus 104) is controlled to tune in the multimedia channel CH1 for deriving a multimedia content such as a video stream S1. For example, when the electronic apparatus 104 receives a switch channel signal, the electronic apparatus 104 requests other electronic apparatuses for multimedia contents of the multimedia channels CH2, CH3, and CH4 to be previewed. As mentioned above, each of the electronic apparatuses 104, 106, 108, 110, and 112 notifies the server 102 to update channel information (mapping) of the selected multimedia channel for updating information associated with a multimedia channel currently selected by the corresponding electronic apparatus. In other words, the multimedia system 100 shown in FIG. 1 employs a centralized server architecture to keep channel information (mapping) of all of the clients (e.g., electronic apparatuses 104, 106, 108, 110, and 112). More specifically, the multimedia system 100 shown in FIG. 1 employs the centralized server architecture to manage availability such as mapping availability of all of the clients (e.g., electronic apparatuses 104, 106, 108, 110, and 112). Therefore, when the user configures the electronic apparatus 104 to present channel previews of the multimedia channels CH2, CH3, and CH4 different from the multimedia channel CH1 which the tuner 114 is going to select or has been selected, the electronic apparatus 104 generates a request to the server 102 for inquiring information of at least an electronic apparatus and a corresponding multimedia channel thereof. In this exemplary implementation, the request generated from the electronic apparatus 104 to the server is for inquiring which electronic apparatuses tune in the desired multimedia channels CH2, CH3, and CH4. Based on the channel information recorded therein, the server 102 generates a response in response to the request of the electronic apparatus 104. In this exemplary embodiment, the electronic apparatus 104 follows the information given in the response of the server 102 to request the electronic apparatus 106 or 112 for a multimedia content S2′ corresponding to a video stream S2 derived from the multimedia channel CH2 selected by the tuner 126 or 132, request the electronic apparatus 108 for a multimedia content S3′ corresponding to a video stream S3 derived from the multimedia channel CH3 selected by the tuner 128, and request the electronic apparatus 110 for a multimedia content S4′ corresponding to a video stream S4 derived from the multimedia channel CH4 selected by the tuner 130. Though the electronic apparatus 104 does not use the tuner 114 to select any of the multimedia channels CH2, CH3, and CH4, the electronic apparatus 104 can obtain channel preview information of the multimedia channels CH2, CH3, and CH4 from other electronic apparatuses through a peer-to-peer communication over the computer network 101. Therefore, in addition to presenting the multimedia content (i.e., the video stream S1) derived from the selected multimedia channel CH1 to the user, the electronic apparatus 104 presents the channel preview information (e.g., the multimedia contents S2′, S3′ and S4′) received from the computer network 101. For example, the channel preview information (e.g., the multimedia contents S2′, S3′ and S4′) is presented as thumbnails on the electronic apparatus 104.

Similarly, as shown in FIG. 1, when the channel preview information of the multimedia channel CH1 selected by the tuner 114 is requested by one of the electronic apparatuses 106, 108, 110, and 112, the electronic apparatus 104 outputs a multimedia content derived from the video stream S1 through a peer-to-peer communication over the computer network 101.

As shown in FIG. 1, the tuner 126 of the electronic apparatus 106 and the tuner 132 of the electronic apparatus 112 both tune in the same multimedia channel, say, the multimedia channel CH2. In one implementation, the server 102 instructs the electronic apparatus 104 to request any of the electronic apparatuses 106 and 112 for the multimedia content S2′. In another implementation, as the server 102 is a centralized server which receives all of the requests generated from the clients, the server 102 knows each client's load on offering its multimedia content requested by other client(s), and therefore instructs the electronic apparatus 104 to request one of the electronic apparatuses 106 and 112 that has a lowest load on providing the requested multimedia content S2′ corresponding to the multimedia channel CH2. More specifically, in a case where a particular electronic apparatus included in a plurality of electronic apparatuses tuning in the desired multimedia channel has a lowest load on providing the multimedia content corresponding to the desired multimedia channel, the server 102 generates a response to instruct data retrieval of the multimedia content from the particular electronic apparatus, thereby balancing the loads of the clients in the multimedia system 100.

For instance, the server 102 can be configured to collect loading of each electronic apparatus according to updated information provided by the electronic apparatuses, and then create an electronic apparatus priority list (PL) for any electronic apparatus (e.g., the electronic apparatus 104) to request for a multimedia content. In one exemplary implementation, the server 102 generates a response according to the electronic apparatus priority list (PL) when receiving a request from an electronic apparatus (e.g., the electronic apparatus 104). In another exemplary implementation, the server 102 transmits the electronic apparatus priority list (PL) to an electronic apparatus (e.g., the electronic apparatus 104) which generates a request. In this way, the electronic apparatus (e.g., the electronic apparatus 104) receives a response (i.e., the electronic apparatus priority list PL) from the server 102 to thereby request one electronic apparatus for a desired multimedia content.

The above merely serves as one possible implementation; however, other implementations capable of achieving the same objective are feasible. For example, in one alternative design, each electronic apparatus is configured to provide a loading status to the server 102, where the loading status shows a quantity of requests from other electronic apparatuses; in another alternative design, each electronic apparatus is configured to provide a loading status to the server 102, where the loading status shows processor usage (also called CPU usage) of the corresponding electronic apparatus; and in yet another alternative design, each electronic apparatus is configured to provide a loading status to the server 102, where the loading status shows network traffic between the corresponding electronic apparatus and other electronic apparatus. In this way, the server 102 directly knows loads of electronic apparatuses (i.e., clients) in the multimedia system 100 according to loading statuses of the electronic apparatuses, and then efficiently accomplishes the objective of balancing loads of electronic apparatuses in the multimedia system 100. All of the aforementioned exemplary designs all fall within the scope of the present invention.

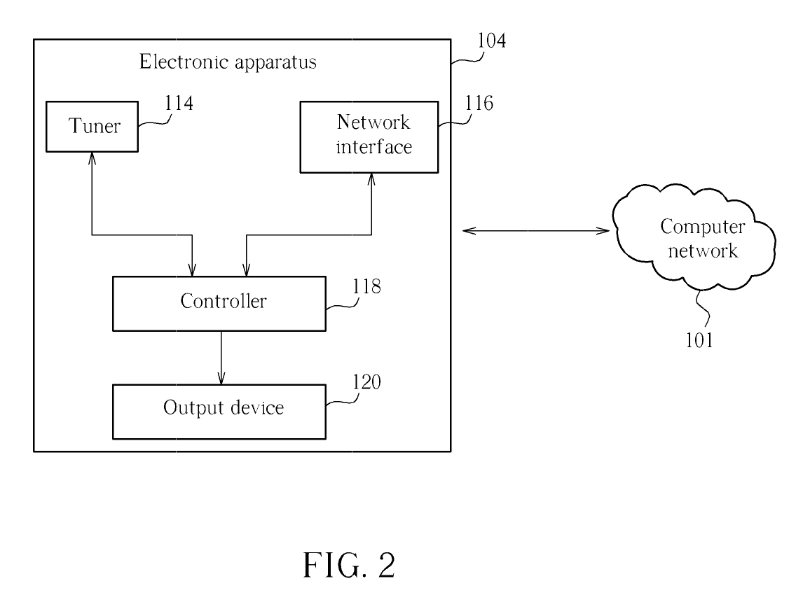

Please refer to FIG. 2. FIG. 2 is a block diagram illustrating an exemplary embodiment of the electronic apparatus 104 shown in FIG. 1. As the electronic apparatuses 104, 106, 108, 110, and 112 have the same structure to support the channel preview scheme proposed by the present invention, only the structure of the electronic apparatus 104 is illustrated for simplicity. In this exemplary embodiment, the electronic apparatus 104 includes the tuner 114 shown in FIG. 1, a network interface 116, a controller 118, and an output device 120. The tuner 114 is implemented to tune in one of a plurality of multimedia channels to derive a multimedia content (e.g., the video stream S1) from a selected multimedia channel (e.g., the multimedia channel CH1). The network interface 116 is equipped with the networking capability, and is implemented for receiving at least a multimedia content from the computer network 101 coupled to the network interface 116, wherein the received multimedia content is derived from at least one of the multimedia channels. For example, the network interface 116 receives the multimedia contents S2′, S3′ and S4′ from the computer network 101. The controller 118 is coupled to the tuner 114, the network interface 116, and the output device 120, and is implemented for controlling operations of the tuner 114 and the network interface 116, and controlling the output device 120 to present the multimedia contents S1, S2′, S3′ and S4′ to the user of the electronic apparatus 104.

In this exemplary embodiment shown in FIG. 2, the output device 120 is integrated in the electronic apparatus 104. For instance, in a case where the multimedia contents S1, S2′, S3′ and S4′ include video contents such as television programs, the electronic apparatus 104 is a mobile phone or a laptop computer with the tuner 114 attached thereto or embedded therein, and the output device 120 is the display panel. However, in an alternative design, the output device 120 is external to the electronic apparatus 104. For instance, the electronic apparatus 104 is a host of a desktop computer system with the tuner 114 attached thereto or embedded therein, and the output device 120 is an external display apparatus electrically connected to the host. Such an alternative design of the electronic apparatus still obeys the spirit of the present invention.

Furthermore, in one implementation where the electronic apparatuses 106, 108, 110, and 112 have weak computing power, the multimedia contents S2′, S3′, and S4′ comprise still images extracted from the video streams S2, S3, and S4 derived from the corresponding multimedia channels CH2, CH3, and CH4. Besides, the electronic apparatuses further generate timestamps respectively corresponding to the still images to the electronic apparatus 104. That is, the network interface 116 of the electronic apparatus 104 further receives timestamps respectively corresponding to the still images from the computer network 101, and the controller 118 controls the output device 120 to display the still images according to the timestamps. With the help of the timestamps, the still images are displayed at the accurate timings. In this way, the display quality of the channel previews of the multimedia channels CH2, CH3, and CH4 can be improved greatly.

In another implementation where the electronic apparatuses 106, 108, 110, and 112 have powerful computing power, the multimedia contents S2′, S3′, and S4′ comprise video streams (i.e., films) derived from the corresponding multimedia channels CH2, CH3, and CH4. Briefly summarized, the present invention does not limit the format of the channel preview information provided by other electronic apparatuses through the computer network 101.

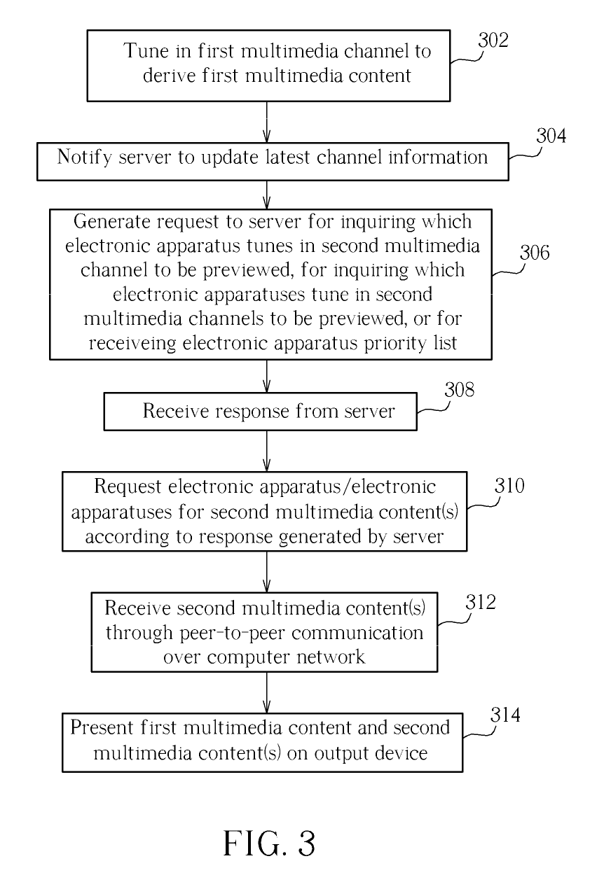

Please refer to FIG. 3. FIG. 3 is a flowchart illustrating an operation of the electronic apparatus 104 which acts as a client in the multimedia system 100 shown in FIG. 1. The operation of the electronic apparatus 104 can be briefly summarized as follows:

Step 302: Tune in a first multimedia channel of a plurality of multimedia channels to derive a first multimedia content.

Step 304: Notify the server 102 to update the latest channel information.

Step 306: Generate a request to the server 102 for inquiring which electronic apparatus tunes in a second multimedia channel to be previewed, for inquiring which electronic apparatuses tune in second multimedia channels to be previewed, or for receiving an electronic apparatus priority list.

Step 308: Receive a response from the server 102.

Step 310: Request an electronic apparatus or electronic apparatuses for the second multimedia content(s) according to the response generated by the server 102.

Step 312: Receive the second multimedia content(s) through a peer-to-peer communication over a computer network 101.

Step 314: Present the first multimedia content and the second multimedia content(s) on an output device 120.

It should be noted that if the result is substantially the same, the steps are not required to be executed in the exact order shown in FIG. 3. For example, the order of controlling the tuner 114 to tune in a specific multimedia channel and requesting the channel preview information of other multimedia channel(s) different from the specific multimedia channel can be adjusted according to design requirements. In addition, as a person skilled in the pertinent art can readily understand the operations of the steps shown in FIG. 3 after reading above paragraphs, further description is omitted here for brevity.

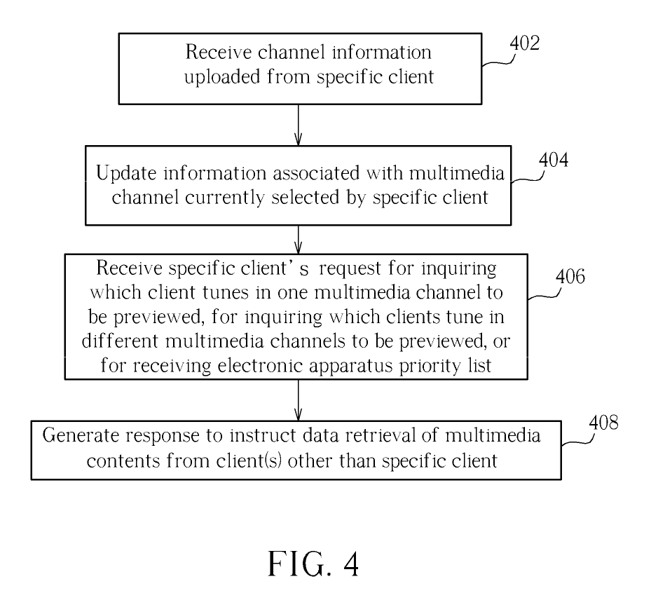

Please refer to FIG. 4. FIG. 4 is a flowchart illustrating an operation of the server 102 in the multimedia system 100 shown in FIG. 1. The operation of the server 102 can be briefly summarized as follows:

Step 402: Receive channel information uploaded from a specific client (e.g., the electronic apparatus 104).

Step 404: Update information associated with a multimedia channel currently selected by the specific client according to the received channel information.

Step 406: Receive the specific client's request for inquiring which client (electronic apparatus) tunes in one multimedia channel to be previewed, for inquiring which clients (electronic apparatuses) tune in multimedia channels to be previewed, or for receiving an electronic apparatus priority list.

Step 408: Generate a response to instruct data retrieval of multimedia contents from client(s) other than the specific client (e.g., the electronic apparatus 104).

Similarly, if the result is substantially the same, the steps are not required to be executed in the exact order shown in FIG. 4. In addition, as a person skilled in the pertinent art can readily understand the operations of the steps shown in FIG. 4 after reading above paragraphs, further description is omitted here for brevity.

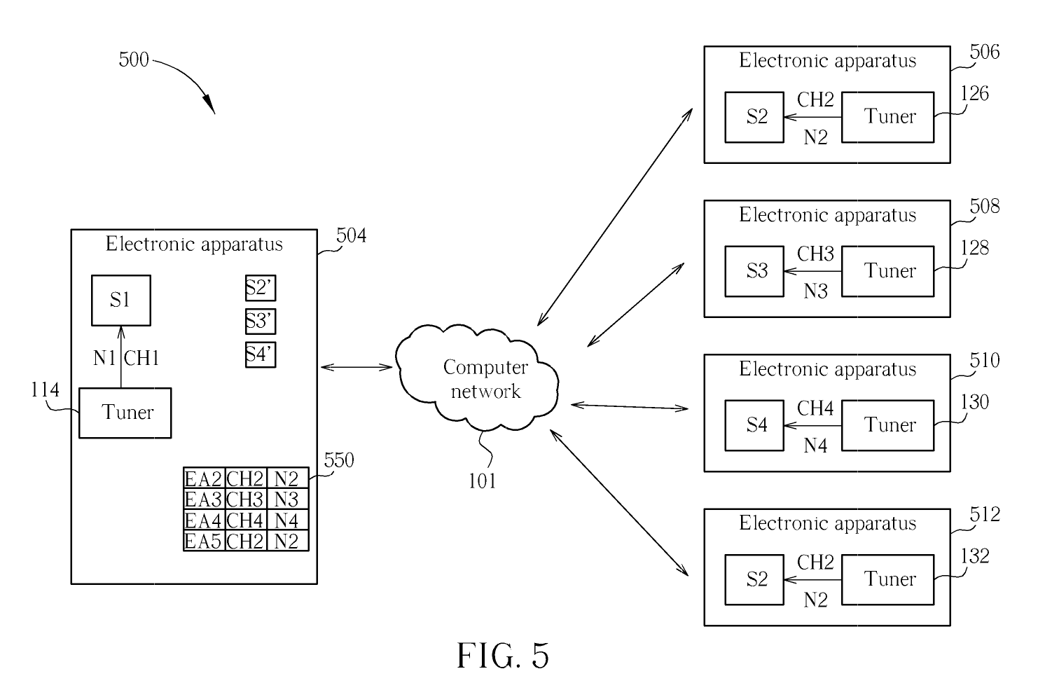

The multimedia system 100 shown in FIG. 1 employs a centralized server architecture; however, this is merely one of the exemplary embodiments of the present invention, and is not meant to be a limitation to the scope of the present invention. Please refer to FIG. 5. FIG. 5 is a schematic diagram illustrating another exemplary embodiment of a multimedia system according to the present invention. In this exemplary embodiment, the multimedia system 500 includes, but is not limited to, a computer network 101 and a plurality of electronic apparatuses 504, 506, 508, 510, 512 which act as servers. In this exemplary embodiment, the electronic apparatuses 504, 506, 508, 510, 512 support the same channel preview scheme proposed by the present invention. It should be noted that the number of electronic apparatuses (servers) shown in FIG. 5 is for illustrative purposes only, and is not meant to be a limitation to the scope of the present invention.

The major difference between the exemplary multimedia system 100 in FIG. 1 and the exemplary multimedia system 500 in FIG. 5 is that each of the electronic apparatuses 504, 506, 508, 510, and 512 records channel information of other electronic apparatuses. By way of example, but not limitation, each electronic apparatus transmits its channel information to other electronic apparatuses and receives channel information of other apparatuses through a peer-to-peer communication over the computer network 101. More specifically, in this exemplary embodiment, the electronic apparatus 504 will upload its channel information to electronic apparatuses 506, 508, 510, and 512; the electronic apparatus 506 will upload its channel information to electronic apparatuses 504, 508, 510, and 512; the electronic apparatus 508 will upload its channel information to electronic apparatuses 504, 506, 510, and 512; the electronic apparatus 510 will upload its channel information to electronic apparatuses 504, 506, 508, and 512; and the electronic apparatus 512 will upload its channel information to electronic apparatuses 504, 506, 508, and 510.

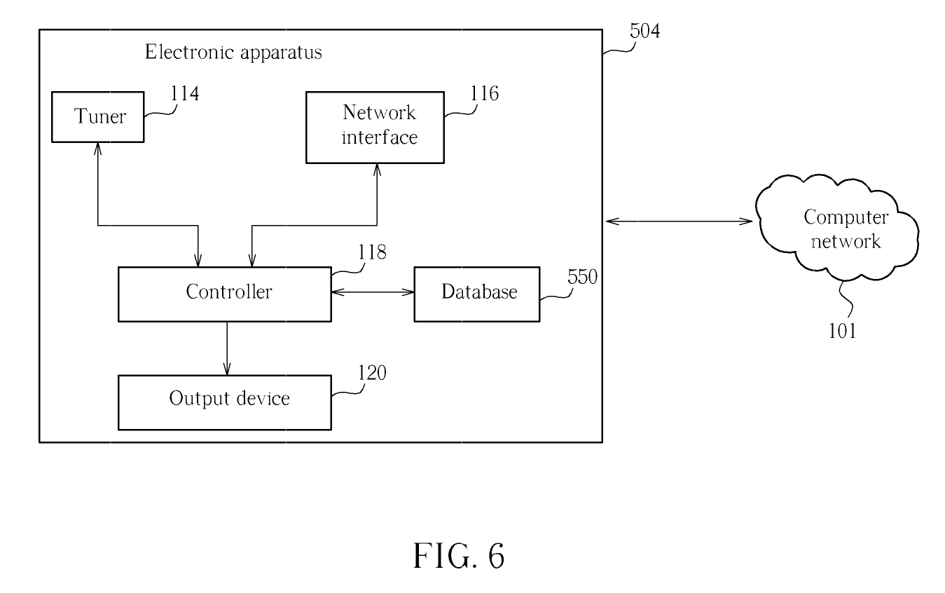

Taking the electronic apparatus 504 for example, it has a database 550 which stores the channel information of other electronic apparatuses 506, 508, 510, and 512. FIG. 6 is a block diagram illustrating an exemplary embodiment of the electronic apparatus 504 shown in FIG. 5. As the electronic apparatuses 504, 506, 508, 510, and 512 have the same structure to support the channel preview scheme proposed by the present invention, only the structure of the electronic apparatus 504 is illustrated for simplicity. In this exemplary embodiment, the electronic apparatus 504 includes the tuner 114, the network interface 116, the controller 118, the output device 120 and the database 550 shown in FIG. 5. Therefore, when the user of the electronic apparatus 504 wants to have channel previews of multimedia channels CH2, CH3, and CH4, the controller 118 refers to data stored in the database 550 to request the electronic apparatus 506 or 512 for a multimedia content S2′ corresponding to a video stream S2 derived from the multimedia channel CH2 selected by the tuner 126 or 132, request the electronic apparatus 508 for a multimedia content S3′ corresponding to a video stream S3 derived from the multimedia channel CH3 selected by the tuner 128, and request the electronic apparatus 510 for a multimedia content S4′ corresponding to a video stream S4 derived from the multimedia channel CH4 selected by the tuner 130. As a person skilled in the pertinent art can readily understand the operation and function of the multimedia system 500 in FIG. 5 and the electronic apparatus 504 in FIG. 6 after reading above paragraphs directed to the multimedia system 100 in FIG. 1 and the electronic apparatus 104 in FIG. 2, further description is omitted here for brevity.

In above exemplary embodiments, each electronic apparatus is equipped with a single tuner. However, this is not meant to be limitation to the scope of the present invention. Actually, the proposed channel preview scheme which derives channel preview information from other data source(s) through the computer network can be applied to an electronic apparatus with more than one tuner.

In view of above disclosure, the method employed by the exemplary multimedia systems 100 and 500 for allowing an electronic apparatus to present multimedia contents of multiple multimedia channels simultaneously can be briefly summarized as follows: tuning in a first multimedia channel of a plurality of multimedia channels for deriving a first multimedia content from the first multimedia channel, and transmitting the first multimedia content via a computer network; tuning in a second multimedia channel of the multimedia channels for deriving a second multimedia content from the second multimedia channel; receiving the first multimedia content from the computer network; and presenting the first multimedia content which is received from the computer network and the second multimedia content on an output device. In this way, the user can still watch the desired multimedia content of a specific multimedia channel while previewing multimedia content(s) of other multimedia channel(s).

Those skilled in the art will readily observe that numerous modifications and alterations of the device and method may be made while retaining the teachings of the invention.

What is claimed is:

1. An electronic apparatus, comprising:
a tuner, for tuning in one of a plurality of multimedia channels to derive a first multimedia content from a selected multimedia channel;
a network interface, for receiving a second multimedia content from a computer network coupled to the network interface, wherein the second multimedia content is derived from at least one of the multimedia channels; and
a controller, coupled to the tuner and the network interface, for controlling operations of the tuner and the network interface, and controlling an output device to present the first multimedia content and the second multimedia content.

2. The electronic apparatus of claim 1, wherein the multimedia channels comprise television channels.

3. The electronic apparatus of claim 1, wherein the second multimedia content comprises still images extracted from a video stream derived from the at least one of the multimedia channels.

4. The electronic apparatus of claim 3, wherein the network interface further receives timestamps respectively corresponding to the still images from the computer network, and the controller controls the output device to display the still images according to the timestamps.

5. The electronic apparatus of claim 1, wherein the network interface receives the second multimedia content through a peer-to-peer communication over the computer network.

6. The electronic apparatus of claim 1, wherein the network interface further transmits data derived from the first multimedia content over the computer network when the data derived from the first multimedia content is requested from other electric apparatuses.

7. The electronic apparatus of claim 6, wherein the network interface transmits the data derived from the first multimedia content through a peer-to-peer communication over the computer network.

8. The electronic apparatus of claim 1, wherein the electronic apparatus comprises a database for recording channel information of other electronic apparatuses.

9. The electronic apparatus of claim 8, wherein the electronic apparatus receives the channel information of other electronic apparatuses through a peer-to-peer communication over the computer network.

10. A multimedia system, comprising:
a computer network; and
a plurality of electronic apparatuses, communicating with each other via the computer network, the electronic apparatuses comprising:
a first electronic apparatus, tuning in a first multimedia channel of a plurality of multimedia channels for deriving a first multimedia content from the first multimedia channel; and
a second electronic apparatus, tuning in a second multimedia channel of the multimedia channels for deriving a second multimedia content from the second multimedia channel, and requesting the first electronic apparatus for the first multimedia content via the computer network and presenting the first multimedia content and the second multimedia content.

11. The multimedia system of claim 10, wherein the second electronic apparatus presents the first multimedia content as thumbnail.

12. The multimedia system of claim 10, wherein when the second electric apparatus receives a switch channel preview signal, the second electric apparatus requests another electronic apparatus for desired multimedia content via the computer network.

13. The multimedia system of claim 10, further comprising:
a server, coupled to the computer network, for managing availability of electronic apparatuses.

14. The multimedia system of claim 10, wherein the multimedia channels comprise television channels.

15. The multimedia system of claim 10, wherein the first multimedia content comprises still images extracted from a video stream derived from the first multimedia channel.

16. The multimedia system of claim 15, wherein the first electronic apparatus further transmits timestamps respectively corresponding to the still images to the second electronic apparatus when transmitting the first multimedia content requested by the second electronic apparatus.

17. The multimedia system of claim 10, further comprising:
a server, coupled to the computer network;
wherein the first electronic apparatus further notifies the server to update channel information of the selected first multimedia channel for updating information associated with a multimedia channel currently selected by the first electronic apparatus, and the second electronic apparatus generates a request to the server for inquiring information of at least one electronic apparatus and a corresponding multimedia channel thereof.

18. The multimedia system of claim 17, wherein the request generated from the second electronic apparatus to the server is for inquiring which electronic apparatus tunes in the first multimedia channel.

19. The multimedia system of claim 18, wherein the second electronic apparatus requests the first electronic apparatus for the first multimedia content according to a response generated by the server, wherein the response indicates that the first electronic apparatus tunes in the first multimedia channel.

20. The multimedia system of claim 17, wherein the server comprises a database for recording at least a channel number and a channel name of a multimedia channel currently selected by each of the electronic apparatuses.

21. The multimedia system of claim 17, wherein the second electronic apparatus further notifies the server to update channel information of the selected second multimedia channel for updating information associated with a multimedia channel currently selected by the second electronic apparatus.

22. The multimedia system of claim 17, wherein the server collects loading of each electronic apparatus according to updated information and creates an electronic apparatus priority list for the second electronic apparatus to request for a desired multimedia content.

23. The multimedia system of claim 22, wherein the electronic apparatuses include a plurality of specific electronic apparatuses tuning in the first multimedia channel, where the first electronic apparatus included in the specific electronic apparatuses has a lowest load on providing multimedia contents corresponding to the first multimedia channel; and the server generates a response according to the electronic apparatus priority list to instruct the second electronic apparatus to request the first electronic apparatus for the first multimedia content.

24. The multimedia system of claim 22, wherein the second electronic apparatus receives the electronic apparatus priority list from the server to request one of the electronic apparatuses for the first multimedia content.

25. The multimedia system of claim 22, wherein the second electronic apparatus receives a response from the server to request one of the electronic apparatuses for the first multimedia content.

26. The multimedia system of claim 10, further comprising:
a server, coupled to the computer network;
wherein each electronic apparatus provides a loading status to the server, and the loading status shows a quantity of requests from other electronic apparatus.

27. The multimedia system of claim 10, further comprising:
a server, coupled to the computer network;
wherein each electronic apparatus provides a loading status to the server, and the loading status shows processor usage of the corresponding electronic apparatus.

28. The multimedia system of claim 10, further comprising:
a server, coupled to the computer network;
wherein each electronic apparatus provides a loading status to the server, and the loading status shows network traffic between the corresponding electronic apparatus and other electronic apparatus.

29. The multimedia system of claim 10, wherein the first electronic apparatus further uploads channel information of the selected first multimedia channel to the second electronic apparatus, and the second electronic apparatus requests the first electronic apparatus for the first multimedia content according to the channel information provided by the first electronic apparatus.

30. The multimedia system of claim 29, wherein the first electronic apparatus uploads the channel information of the selected first multimedia channel to the second electronic apparatus through a peer-to-peer communication over the computer network.

31. A method of presenting multimedia contents of multiple multimedia channels, comprising:
tuning in a first multimedia channel of a plurality of multimedia channels for deriving a first multimedia content from the first multimedia channel, and transmitting the first multimedia content via a computer network;
tuning in a second multimedia channel of the multimedia channels for deriving a second multimedia content from the second multimedia channel;
receiving the first multimedia content from the computer network; and
presenting the first multimedia content which is received from the computer network and the second multimedia content on an output device.

32. The method of claim 31, wherein presenting the first multimedia content comprises:
presenting the first multimedia content as thumbnail.

33. The method of claim 31, further comprising:
when a preview switch channel signal is received, requesting the first multimedia content via the computer network.

34. The method of claim 31, wherein the first multimedia content is derived from a first electronic apparatus which is included in a plurality of electronic apparatuses and tunes in the first multimedia channel, the second multimedia content is derived from a second electronic apparatus included in the electronic apparatuses and tunes in the second multimedia channel, and the method further comprises:
managing availability of electronic apparatuses.

35. The method of claim 31, wherein the multimedia channels comprise television channels.

36. The method of claim 31, wherein the first multimedia content comprises still images extracted from a video stream derived from the first multimedia channel.

37. The method of claim 36, wherein transmitting the first multimedia content via the computer network further comprises transmitting timestamps respectively corresponding to the still images; receiving the first multimedia content from the computer network further comprises receiving the timestamps from the computer network; and presenting the second multimedia content on the output device comprises displaying the still images on the output device according to the timestamps.

38. The method of claim 31, wherein the first multimedia content is transmitted through a peer-to-peer communication over the computer network.

39. The method of claim 31, further comprising:
notifying a server to update channel information of the selected first multimedia channel for updating information associated with a multimedia channel currently selected by a first electronic apparatus;
wherein receiving the first multimedia content from the computer network comprises:
generating a request to the server for inquiring information of at least one electronic apparatus and a corresponding multimedia channel thereof.

40. The method of claim 39, wherein the request generated to the server is for inquiring which electronic apparatus tunes in the first multimedia channel.

41. The method of claim 40, wherein receiving the first multimedia content from the computer network further comprises:
requesting the first electronic apparatus for the first multimedia content according to a response generated in response to the request.

42. The method of claim 39, further comprising:
utilizing a database in the server for recording at least a channel number and a channel name of a multimedia channel currently selected by each electronic apparatus.

43. The method of claim 39, further comprising:
notifying the server to update channel information of the selected second multimedia channel for updating information associated with a multimedia channel currently selected by a second electronic apparatus.

44. The method of claim 39, wherein the request is generated from a second electronic apparatus, and the method further comprises:
utilizing the server to collect loading of each electronic apparatus according to updated information and create an electronic apparatus priority list for the second electronic apparatus to request for a multimedia content.

45. The method of claim 44, wherein the first electronic apparatus included in a plurality of specific electronic apparatuses tuning in the first multimedia channel has a lowest load on providing multimedia contents corresponding to the first multimedia channel, and receiving the first multimedia content from the computer network further comprises:
generating the response according to the electronic apparatus priority list to instruct data retrieval of the first multimedia content from the first electronic apparatus.

46. The method of claim 45, wherein the second electronic apparatus receives the electronic apparatus priority list from the server to request one electronic apparatus for the first multimedia content.

47. The method of claim 45, wherein the second electronic apparatus receives a response from the server to request one of the electronic apparatuses for the first multimedia content.

48. The method of claim 31, wherein the first multimedia content is derived from a first electronic apparatus which is included in a plurality of electronic apparatuses and tunes in the first multimedia channel, the second multimedia content is derived from a second electronic apparatus included in the electronic apparatuses and tunes in the second multimedia channel, and the method further comprises:
providing a loading status of each electronic apparatus to a server, wherein the loading status shows a quantity of requests from other electronic apparatus.

49. The method of claim 31, wherein the first multimedia content is derived from a first electronic apparatus which is included in a plurality of electronic apparatuses and tunes in the first multimedia channel, the second multimedia content is derived from a second electronic apparatus included in the electronic apparatuses and tunes in the second multimedia channel, and the method further comprises:
providing a loading status of each electronic apparatus to a server, wherein the loading status shows processor usage of the corresponding electronic apparatus.

50. The method of claim 31, wherein the first multimedia content is derived from a first electronic apparatus which is included in a plurality of electronic apparatuses and tunes in the first multimedia channel, the second multimedia content is derived from a second electronic apparatus included in the electronic apparatuses and tunes in the second multimedia channel, and the method further comprises:
providing a loading status of each electronic apparatus to a server, wherein the loading status shows network traffic between the corresponding electronic apparatus and other electronic apparatus.

51. The method of claim 31, further comprising:
uploading channel information of the first multimedia channel selected by a first electronic apparatus to a second electronic apparatus which tunes in the second multimedia channel;
wherein receiving the first multimedia content from the computer network comprises:
utilizing the second electronic apparatus to request the first electronic apparatus for the first multimedia content according to the channel information provided by the first electronic apparatus.

52. The method of claim 51, wherein the channel information of the selected first multimedia channel is uploaded to the second electronic apparatus through a peer-to-peer communication over the computer network.

53. The method of claim 31, further comprising:
when data derived from the second multimedia content is requested, transmitting the data derived from the second multimedia content over the computer network.

54. The method of claim 53, wherein the data derived from the second multimedia content are transmitted through a peer-to-peer communication over the computer network.
